(19) United States
(12) Patent Application Publication
(10) Pub. No.: US 2017/0024622 A1
(43) Pub. Date: Jan. 26, 2017

(54) SURROUNDING ENVIRONMENT RECOGNITION DEVICE

(71) Applicant: HONDA MOTOR CO., LTD., Tokyo (JP)

(72) Inventors: Akira Mizutani, Utsunomiya-shi (JP); Douglas A. Brooks, San Antonio, TX (US); David R. Chambers, San Antonio, TX (US); Edmond M. Dupont, San Antonio, TX (US)

(73) Assignee: HONDA MOTOR CO., LTD., Tokyo (JP)

(21) Appl. No.: 14/807,926

(22) Filed: Jul. 24, 2015

(51) Int. Cl. G06K 9/00; H04N 7/18

(52) U.S. Cl. CPC G06K 9/00825; H04N 7/183

(57) ABSTRACT

A surrounding environment recognition device includes an image capturing unit that captures a peripheral image, and a traffic signal recognizing unit that recognizes a traffic signal from within the peripheral image. The image capturing unit captures a plurality of images of frames. The traffic signal recognizing unit recognizes the traffic signal based on a combination of the plurality of images of frames.

### BACKGROUND OF THE INVENTION

Field of the Invention

The present invention relates to a surrounding environment recognition device for detecting traffic signal lights using a peripheral image.

Description of the Related Art

In Japanese Laid-Open Patent Publication No. 2012-168592 (hereinafter referred to as “JP 2012-168592A”), a red-light signal Lr, etc., of a traffic signal S is detected based on an image T that is captured by an image capturing means 2, and an arrow signal A, an image of which is captured within a search region Rs set based on the position of the detected red-light signal Lr, etc. in the image T, is extracted (abstract).

In JP 2012-168592A, a stereo matching process is carried out, in which two images acquired by a stereo camera (a reference image T of a main camera 2a and a comparison image Tc of a sub-camera 2b) are combined (paragraphs [0040], [0045], [0046]). In accordance with this feature, a distance image Tz is calculated, in which a parallax value dp is assigned to each of the pixels of the reference image T (paragraph [0048]). In addition, the red-light signal Lr or the like is detected using the distance image Tz (paragraphs [0074], [0075]), and the arrow signal A is extracted based on the position of the detected red-light signal Lr or the like (see FIG. 15). Further, in JP 2012-168592A, it is disclosed that only one image T, as in the case of a monocular camera, may be used (see paragraph [0056]).

### SUMMARY OF THE INVENTION

The inventors of the present invention have discovered that when a monocular camera (a single camera) is used, cases occur in which, even though a red-light signal Lr and an arrow signal A are illuminated simultaneously, the recognition device cannot recognize both the red-light signal Lr and the arrow signal A at the same time. Upon carrying out an investigation into the cause thereof, it was understood that the reason was due to the use of multiple light emitting diode (LED) lamps in the light emitting portions of the traffic signal. More specifically, such LED lamps flash in a specific period that cannot be recognized by the naked eye. Therefore, in images of frames that are captured at timings when the LED lamps are momentarily turned off or not illuminated, the LED lamps that are turned off cannot be recognized as being in an illuminated state. This type of problem is not limited to LED lamps, but similarly is true for other types of lamps that flash on and off at a specified period.

In JP 2012-168592A, even in the case that either one of a stereo camera (the main camera 2a and the sub-camera 2b) or a monocular camera is used, it can be assumed that the red-light signal Lr and the arrow signal A are recognized based on a single frame image. In the case of a stereo camera, it can be assumed that the reference image T and the comparison image Tc are acquired while the main camera 2a and the sub-camera 2b are synchronized. For this reason, even in the case that either one of the stereo camera or the monocular camera is used, there is a concern that the lamps of the traffic signal cannot be recognized with sufficient accuracy.

The present invention has been devised taking into consideration the aforementioned problems, and has the object of providing a surrounding environment recognition device which is capable of improving detection accuracy.

A surrounding environment recognition device according to the present invention includes an image capturing unit that captures a peripheral image, and a traffic signal recognizing unit that recognizes a traffic signal from within the peripheral image. The image capturing unit captures a plurality of images of frames, and the traffic signal recognizing unit recognizes the traffic signal based on a combination of the plurality of images of frames.

According to the present invention, the traffic signal is recognized by a combination of the plurality of images of frames. Therefore, for example, even in the event that the traffic signal is difficult to recognize with a single frame, as in the case of an LED traffic signal, the traffic signal can be recognized accurately.

The surrounding environment recognition device may include a storage unit in which a light emitting pattern of a plurality of frames is stored as teacher data. Further, the traffic signal recognizing unit may recognize the traffic signal by comparing a light emitting pattern of the plurality of frames captured by the image capturing unit and the teacher data. By this feature, since the transition of the light emitting state of an LED traffic signal, etc., is stored as a light emitting pattern and is compared, the LED traffic signal, etc., can be recognized accurately.

The traffic signal recognizing unit may confirm light emitting lamps that are included in one of the plurality of frames that has a greatest number of light emitting lamps therein, as being the light emitting lamps. In accordance with this feature, a plurality of signal lamps (for example, a red-light lamp and an arrow lamp), which are illuminated simultaneously, can be recognized more accurately.

If one of a red-light signal and an arrow signal is recognized in a certain frame, the traffic signal recognizing unit may make it easier for the other of the red-light signal and the arrow signal to be recognized in a next frame thereafter or in a previous frame therebefore. Further, if one of a red-light signal and an arrow signal is recognized in a certain frame, the traffic signal recognizing unit may make it easier for the one of the red-light signal and the arrow signal to be recognized in a next frame thereafter or in a previous frame therebefore. In accordance with this feature, it becomes easier for a plurality of light emitting lamps, which are recognized as being illuminated simultaneously by the naked eye, to be recognized accurately.

The traffic signal recognizing unit may confirm a light emitting lamp whose recognition count in the plurality of frames has exceeded a recognition count threshold, as being the light emitting lamp. By this feature, the illuminated state of a traffic signal can be judged more accurately, so that a light emitting lamp, which would be mistakenly detected in a signal frame, is not confirmed as being the light emitting lamp.

If there are plural light emitting lamps whose respective recognition counts have exceeded the recognition count threshold, and a mutual difference in the recognition count between the light emitting lamps is greater than or equal to a difference threshold, then the traffic signal recognizing unit may confirm only the light emitting lamp having a larger recognition count, as being the light emitting lamp. In accordance with this feature, it is possible to improve the accuracy with which light emitting lamps are recognized by a relationship between the light emitting lamps themselves.

The above and other objects features and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a vehicle in which a surrounding environment recognition device according to an embodiment of the present invention is incorporated;

FIG. 2 is a view showing an example of a peripheral image when a traffic signal detection control process is implemented in the embodiment;

FIG. 3 is a view showing an example of peripheral images corresponding to a plurality of frames and images of a traffic signal therein, in the traffic signal detection control process of the embodiment;

FIG. 4 is a flowchart of the traffic signal detection control process according to the present embodiment;

FIG. 5 is a view for describing teacher data that is used in the present embodiment;

FIG. 6 is a flowchart of a traffic signal detection control process according to a first modification; and

FIG. 7 is a flowchart of a traffic signal detection control process according to a second modification.

### DESCRIPTION OF THE PREFERRED EMBODIMENTS

### A. Embodiment

### A1. Description of Overall Configuration

### (A1-1. Overall Configuration)

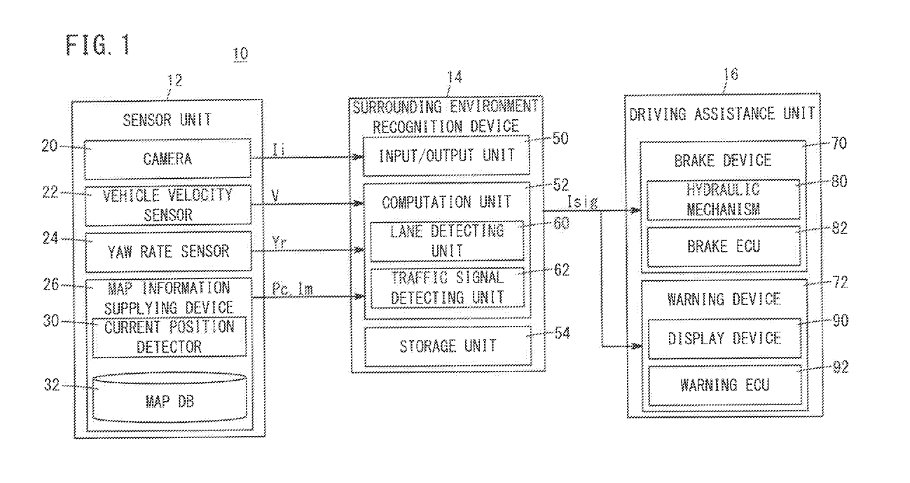

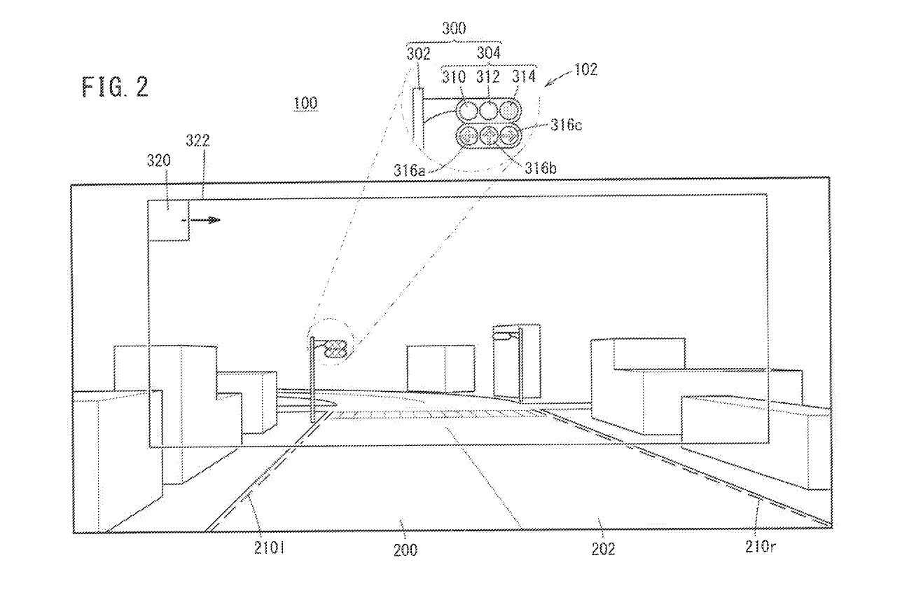

FIG. 1 is a schematic diagram of a vehicle 10 in which a surrounding environment recognition device 14 (hereinafter also referred to as a “recognition device 14”) according to an embodiment of the present invention is incorporated. As shown in FIG. 1, in addition to the recognition device 14, the vehicle 10 includes a sensor unit 12, and a driving assistance unit 16. In the vehicle 10, a traffic signal 300 (see FIG. 2) is detected by the recognition device 14 based on sensor information Is (image information Ii, etc., to be described later) supplied from the sensor unit 12. Information of the detected traffic signal 300 is used in the driving assistance unit 16 for assisting driving of the vehicle 10.

### (A1-2. Sensor Unit 12)

The sensor unit 12 acquires the sensor information Is that is used in the recognition device 14 for detecting the traffic signal 300. As shown in FIG. 1, in the sensor unit 12, there are included a camera 20, a vehicle velocity sensor 22, a yaw rate sensor 24, and a map information supplying device 26.

The camera 20 is an image capturing unit that captures a peripheral image 100 around the vehicle 10 (see FIG. 2), and outputs image information Ii in relation to the peripheral image 100 (hereinafter also referred to simply as an “image 100”). The camera 20 is fixed to the roof or the front windshield of the vehicle 10 through a non-illustrated bracket. The camera 20 of the present embodiment is a color camera. However, the camera 20 may be a monochrome (black and white) camera, insofar as the camera is capable of detecting the traffic signal 300 (see FIG. 2) based on the images 100. The frame rate of the camera 20 can be anywhere from fifteen to fifty frames per second, for example.

The vehicle velocity sensor 22 detects a velocity V [km/h] of the vehicle 10. The yaw rate sensor 24 detects a yaw rate Yr [deg/sec] of the vehicle 10.

The map information supplying device 26 supplies map information Im as information (peripheral information) relating to the surrounding area of the vehicle 10. The map information supplying device 26 includes a current position detector 30 and a map information database 32 (hereinafter referred to as a “map DB 32”). The current position detector 30 detects a current position Pc of the vehicle 10. The map DB 32 stores map information Im including positions of traffic signals 300 therein. Such positions can be defined comparatively roughly, so as to indicate which intersection has a traffic signal 300, for example. Alternatively, each of the positions Ps of the traffic signals 300 may be defined with comparatively high detail, including a front and back location in the intersection, a height H, and a left and right (lateral) location, etc. Furthermore, the map information Im may also include the shape (vertically elongate, horizontally elongate, etc.) of a light emitting section 304 (see FIG. 2) of the traffic signal 300.

The map information supplying device 26 calculates a distance Lsmap [m] from the vehicle 10 (camera 20) to the traffic signal 300 based on the current position Pc and the position Ps of the traffic signal 300, and supplies the same as distance information Ilmap to the recognition device 14. The distance information Ilmap makes up a portion of the map information Im.

The map information supplying device 26 can be configured as a navigation device, for example. Alternatively, the map information supplying device 26 may be a device that supplies the map information Im to the recognition device 14 without performing route guidance for the benefit of the driver.

### (A1-3. Surrounding Environment Recognition Device 14)

The surrounding environment recognition device 14 detects a traffic signal 300 that is present in the direction of travel of the vehicle 10. As shown in FIG. 1, the recognition device 14 includes, as hardware components thereof, an input/output unit 50, a computation unit 52, and a storage unit 54. The recognition device 14 is constituted as an electronic control unit (ECU) including a central processing unit (CPU) or the like. The input/output unit 50 performs input and output of signals to and from the sensor unit 12 and the driving assistance unit 16.

The computation unit 52 serves to control the recognition device 14 as a whole, and operates by executing programs that are stored in the storage unit 54. The programs may be supplied externally through a non-illustrated wireless communications device (a portable telephone, a smartphone, or the like). A portion of such programs can be constituted as hardware (circuit components).

The computation unit 52 includes a lane detecting unit 60 and a traffic signal detecting unit 62 (traffic signal recognizing unit). The lane detecting unit 60 detects or recognizes lanes 210l, 210r (see FIG. 2) in the direction of travel of the vehicle 10, and outputs lane information Il in relation to the lanes 210l, 210r. The traffic signal detecting unit 62 detects a traffic signal 300, and outputs traffic signal information Isig in relation to the traffic signal 300. Details concerning the controls (traffic signal detection control process) in the computation unit 52 will be described later with reference to FIGS. 2 through 4.

The storage unit 54 is constituted by a random access memory (RAM) for temporarily storing data, etc., which is subjected to various computational processes, and a read only memory (ROM) in which executable programs, tables, maps, etc., are stored. The storage unit 54 of the present embodiment stores, as teacher data, light emitting patterns Pl (or illumination patterns) for facilitating detection of the traffic signals 300.

### (A1-4. Driving Assistance Unit 16)

The driving assistance unit 16 performs driving assistance for the vehicle 10 using the calculation results of the recognition device 14. The driving assistance unit 16 includes a brake device 70 and a warning device 72. The brake device 70 serves to control a braking force of the vehicle 10, and includes a hydraulic mechanism 80 and a brake electronic control unit 82 (hereinafter referred to as a “brake ECU 82”). The brake ECU 82 controls the hydraulic mechanism 80 based on the traffic signal information Isig from the recognition device 14. The brake in this case is assumed to be a frictional brake in which the hydraulic mechanism 80 is used. However, in addition to or in place of frictional braking, a system may be provided in which one or both of engine braking and regenerative braking are controlled.

The warning device 72 notifies the driver of an illuminated state of the traffic signal 300, in particular, a red light signal (i.e., a state in which a red-light lamp 314 of the traffic signal 300 is illuminated). The warning device 72 includes a display device 90 and a warning electronic control unit 92 (hereinafter referred to as a “warning ECU 92”). The warning ECU 92 controls the display of the display device 90 based on the traffic signal information Isig from the recognition device 14.

### A2. Various Control Processes

### (A2-1. Outline)

With the vehicle 10 of the present embodiment, a traffic signal 300 is detected (or recognized) using the surrounding environment recognition device 14. In addition, driving assistance for the vehicle 10 is carried out based on the information of the detected traffic signal 300. In the driving assistance, for example, there may be included automatic braking, in the case that the vehicle 10 approaches too closely to a traffic signal 300 illuminated with a red-light signal, and a notification of the approach to the traffic signal 300 illuminated with the red-light signal.

Hereinbelow, the control process by which the surrounding environment recognition device 14 detects traffic signals 300 is referred to as a “traffic signal detection control process”. Further, the control process by which the driving assistance unit 16 carries out driving assistance is referred to as a “driving assistance control process”.

### (A2-2. Traffic Signal Detection Control Process)

### (A2-2-1. Outline of Traffic Signal Detection Control Process)

FIG. 2 is a view showing an example of a peripheral image 100 when the traffic signal detection control process is implemented according to the present embodiment. FIG. 2 shows a case in which the vehicle 10 travels on the left side of the road. Therefore, the traveling lane 200 of the vehicle 10 (driver's own vehicle) is on the left side, and the opposing lane 202 is on the right side. The traffic signal 300 shown in FIG. 2 includes a supporting post 302 and a light emitting section 304. The light emitting section 304 includes a green-light lamp 310, a yellow-light lamp 312, a red-light lamp 314 and three arrow lamps 316a, 316b, 316c.

The arrow lamp 316a is a lamp that indicates permission to make a left turn, and hereinafter also is referred to as a “left turn permission lamp 316a”. The arrow lamp 316b is a lamp that indicates permission to travel straight forward, and hereinafter also is referred to as a “straight forward permission lamp 316b”. The arrow lamp 316c is a lamp that indicates permission to make a right turn, and hereinafter also is referred to as a “right turn permission lamp 316c”. Below, the arrow lamps 316a, 316b, 316c will be referred to collectively as “arrow lamps 316”.

Further, as shown in FIG. 2, with the traffic signal detection control process, at least one search window 320 is used. The search window 320 sets a range within which traffic signals 300 are searched for, and is moved within (or scans) an image 100 for each frame F. According to the present embodiment, the traffic signal 300 is detected by combining the results of moving the search window 320 or scanning with the search window 320 for a plurality of frames F. Further, a search region 322 over which the search window 320 is moved within the image 100 is not the entirety of the image 100, but rather covers only a portion of the image 100. For example, in FIG. 2, the search window 320 is not caused to scan over regions in which it is thought that the traffic signal 300 cannot be detected. Alternatively, the entirety of the image 100 may be used as the search region 322.

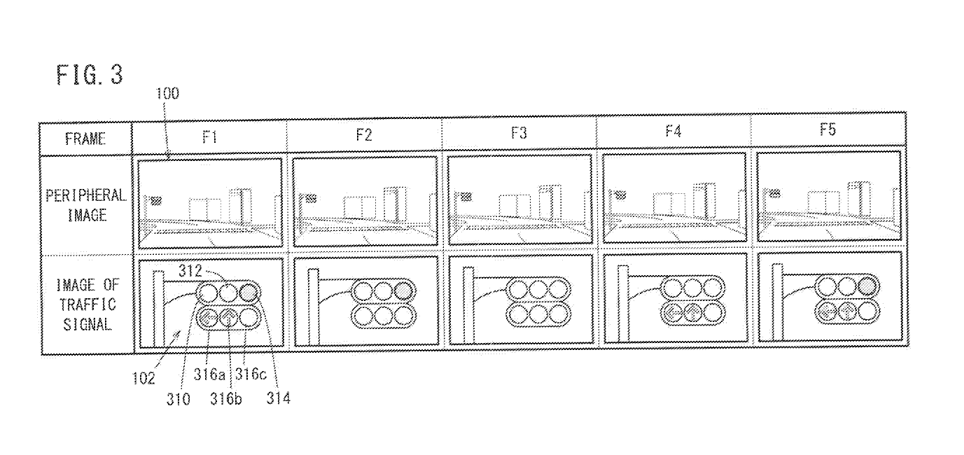

FIG. 3 is a view showing an example of peripheral images 100 corresponding to a plurality of frames, and images 102 of the traffic signal 300 therein, in the traffic signal detection control process according to the present embodiment. The traffic signal 300 shown in FIG. 3 is an LED traffic signal. In the example of FIG. 3, as seen with the naked eye, the red-light lamp 314, the left turn permission lamp 316a, and the straight forward permission lamp 316b are illuminated, whereas the green-light lamp 310, the yellow-light lamp 312, and the right turn permission lamp 316c are turned off. However, the lamps 310, 312, 314, and 316a to 316c flash separately at respective specified periods. Therefore, the lamps (light emitting lamps Ll) that are emitting light differ in each of the frames F1 to F5.

More specifically, in frame F1 of FIG. 3, the red-light lamp 314, the left turn permission lamp 316a, and the straight forward permission lamp 316b are illuminated, whereas the green-light lamp 310, the yellow-light lamp 312, and the right turn permission lamp 316c are turned off. In the following frame F2, only the red-light lamp 314 is illuminated, whereas the other lamps 310, 312, and 316a to 316c are turned off. In frame F3, all of the lamps 310, 312, 314, and 316a to 316c are turned off. In frame F4, the arrow lamps 316a, 316b are illuminated, whereas the other lamps 310, 312, 314, and 316c are turned off. In frame F5, similar to frame F1, the red-light lamp 314, the left turn permission lamp 316a, and the straight forward permission lamp 316b are illuminated, whereas the green-light lamp 310, the yellow-light lamp 312, and the right turn permission lamp 316c are turned off.

In each of the frames F1 to F5, the red-light lamp 314, the left turn permission lamp 316a, and the straight forward permission lamp 316b are actually flashing. However, to the naked eye, the red-light lamp 314, the left turn permission lamp 316a, and the straight forward permission lamp 316b are seen as being illuminated continuously.

In the case that the red-light lamp 314, the left turn permission lamp 316a, and the straight forward permission lamp 316b are flashing, if only an image 100 of a single frame F is used, there is a concern that the lamps that are emitting light (hereinafter referred to as “light emitting lamps Ll”) will be mistakenly recognized. Thus, in the traffic signal detection control process of the present embodiment, the traffic signal 300 (or the light emitting lamps Ll thereof) is recognized by combining the images 100 of a plurality of frames F.

### (A2-2-2. Overall Flow of Traffic Signal Detection Control Process)

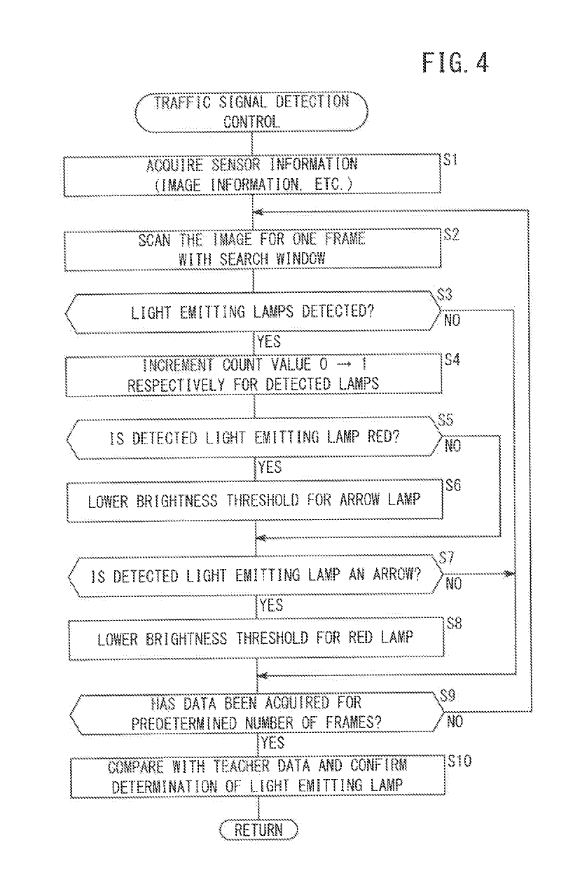

FIG. 4 is a flowchart of the traffic signal detection control process according to the present embodiment. The respective process steps shown in FIG. 4 are executed in the computation unit 52 (in particular, the traffic signal detecting unit 62) of the surrounding environment recognition device 14. In step S1 of FIG. 4, the recognition device 14 acquires various sensor information Is from the sensor unit 12. The sensor information Is in this case includes the image information Ii from the camera 20, the vehicle velocity V from the vehicle velocity sensor 22, the yaw rate Yr from the yaw rate sensor 24, and the current position Pc and the map information Im from the map information supplying device 26. As will be discussed later, it also is possible that only the map information Ii is acquired.

In step S2, the computation unit 52 controls the search window 320 to scan (or move over) the image 100 for one frame. Consequently, the computation unit 52 can detect the light emitting lamp Ll. Moreover, as will be described in detail later, the computation unit 52 can change the search region 322 based on the vehicle velocity V, the yaw rate Yr, and the map information Im, etc.

In relation to scanning by the search window 320, for example, while the search window 320 scans the search region 322 from the left side to the right side, the traffic signal detecting unit 62 determines whether or not certain characteristics (e.g., shape, color, brightness, etc.) of the light emitting section 304 or the respective lamps 310, 312, 314, and 316a to 316c of the traffic signal 300 exist inside of the search window 320. Next, while the search window 320 scans the search region 322 from the left side to the right side at a position lowered by a predetermined distance, the computation unit 52 determines whether or not such characteristics (e.g., shape, color, brightness, etc.) of the traffic signal 300 exist inside of the search window 320. By repeating the above steps, the search window 320 scans over the entirety of the search region 322.

Further, during scanning by the search window 320, the current position of the search window 320 is set so as to overlap with the previous position of the search window 320 at which a judgment was made as to the existence of characteristics of the traffic signal 300. Stated otherwise, the offset amount from the previous search window 320 to the current search window 320 is shorter than the width of the search window 320 (for example, about one-half of the width thereof). Owing thereto, even in the case that only a portion of the characteristics of the traffic signal 300 appear within the previous search window 320 so that the traffic signal 300 cannot be detected, the entire characteristics of the traffic signal 300 appear within the present search window 320, whereby it is possible to enhance the accuracy with which the traffic signal 300 is detected. Further, overlapping of the previous position and the current position is not only in the widthwise direction, but can also be performed in the vertical direction.

In step S3, the computation unit 52 determines whether or not light emitting lamps Ll of any type have been detected. As the light emitting lamps Ll, there can be included the green-light lamp 310, the yellow-light lamp 312, the red-light lamp 314, the left turn permission lamp 316a, the straight forward permission lamp 316b, and the right turn permission lamp 316c. Types of lamps apart from those listed above may be included. In the case that one or a plurality of light emitting lamps Ll are detected (step S3: YES), then in step S4, the computation unit 52 changes the count values CNT from 0 to 1 respectively for the detected light emitting lamps Ll.

In step S5, the computation unit 52 judges whether or not the red-light lamp 314 is included in the detected light emitting lamps Ll. If the red-light lamp 314 is included in the detected light emitting lamps Ll (step S5: YES), the process proceeds to step S6. If the red-light lamp 314 is not included in the detected light emitting lamps Ll (step S5: NO), the process proceeds to step S7. In step S6, for the following three frames F thereafter, the computation unit 52 lowers a brightness threshold THb for the arrow lamps 316a, 316b, 316c. Consequently, in the following three frames F, it becomes easier for the arrow lamps 316a, 316b, 316c to be detected. The brightness threshold THb is a threshold value for brightness, which is used at the time that the respective lamps 310, 312, 314, and 316a to 316c are detected in step S2.

In step S7, the computation unit 52 judges whether or not any of the arrow lamps 316a, 316b, 316c are included in the detected light emitting lamps Ll. If any of the arrow lamps 316a, 316b, 316c are included in the detected light emitting lamps Ll (step S7: YES), the process proceeds to step S8. If no arrow lamps 316a, 316b, 316c are included in the detected light emitting lamps Ll (step S7: NO), the process proceeds to step S9. In step S8, for the following three frames F thereafter, the computation unit 52 lowers a brightness threshold THb for the red-light lamp 314. Consequently, in the following three frames F, it becomes easier for the red-light lamp 314 to be detected.

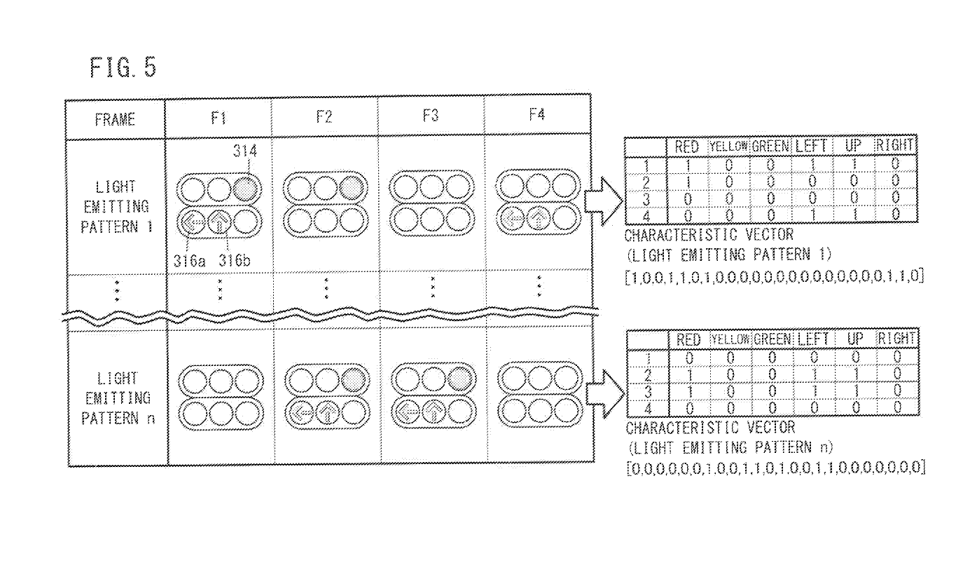

In step S9, the computation unit 52 determines whether or not data of a predetermined number of frames Nf have been acquired. The predetermined number of frames Nf can be from four to ten, for example. In the present embodiment the predetermined number of frames Nf is four. Further, the data in this case is data relating to light emitting patterns Pl, and is defined by count values CNT of the respective lamps 310, 312, 314, and 316a to 316c in each of the frames F (details thereof will be described later with reference to FIG. 5). If data of the predetermined number of frames Nf have not been acquired (step S9: NO), the process returns to step S2. If data of the predetermined number of frames Nf have been acquired (step S9: YES), the process proceeds to step S10.

In step S10, the computation unit 52 compares the acquired data of the predetermined number of frames Nf with teacher data to thereby confirm the presence of the light emitting lamps Ll.

FIG. 5 is a view for describing the teacher data that is used in the present embodiment. As shown in FIG. 5, according to the present embodiment, in the four consecutive frames F1 to F4, characteristic vectors Vc concerning the respective light emitting patterns Pl are stored beforehand in the storage unit 54.

As shown in FIG. 5, the characteristic vector Vc may be defined, for example, by the sequence “1,0,0,1,1,0,1,0,0,0,0,0,0,0,0,0,0,0,0,0,0,1,1,0”. In the sequence, the initial six values thereof correspond to the frame F1, the next six values thereof correspond to the frame F2, the next six values thereof correspond to the frame F3, and the last six values thereof correspond to the frame F4.

Further, as shown in FIG. 5, in each combination of the six values, the six values correspond respectively to the red-light signal (red-light lamp 314), the yellow-light signal (yellow-light lamp 312), the green-light signal (green-light lamp 310), the left turn permission signal (arrow lamp 316a), the straight forward permission signal (arrow lamp 316b), and the right turn permission signal (arrow lamp 316c). In such combinations, the value “1” is assigned to the light emitting lamps Ll, whereas the value “0” is assigned to lamps that are not emitting light.

In addition, by comparing the characteristic vectors Vc that are stored in the storage unit 54 with the characteristic vectors Vc (count values CNT) of the four frames F1 to F4 that have actually been detected, the computation unit 52 determines which one of the light emitting patterns Pl the traffic signal corresponds to, or matches the traffic signal with any one of the light emitting patterns Pl. Furthermore, the computation unit 52 specifies the light emitting lamps Ll based on the determined light emitting pattern Pl.

The computation unit 52 performs the process of FIG. 4 for each combination of the predetermined number of frames Nf. For example, the process of FIG. 4 is carried out in the order of a combination of frames F1 to F4, a combination of frames F2 to F5, and a combination of frames F3 to F6 (in other words, while the frames F included in the combinations are changed or shifted by one frame each). Alternatively, the process of FIG. 4 can be carried out in the order of a combination of frames F1 to F4, a combination of frames F3 to F6, and a combination of frames F5 to F8 (in other words, while the frames F included in the combinations are changed or shifted by two frames each). Alternatively, the process of FIG. 4 may be carried out while the frames F included in the combinations are changed or shifted by three or four frames each.

### (A2-2-3. Settings for Search Region 322 of Search Window 320 (Step S2 of FIG. 4))

As noted above, according to the present embodiment, the search region 322 of the search window 320 is corrected using the sensor information Is (e.g., the vehicle velocity V, the yaw rate Yr, and the map information Im).

### (A2-2-3-1. Lane Information Il)

In general, the traffic signal 300 exists to the side of or above the traveling lane 200 and/or the opposing lane 202. For this reason, there is a low possibility for the traffic signal 300 to exist at a position that is separated or distanced from the traveling lane 200 and the opposing lane 202. Thus, according to the present embodiment, the position in the widthwise direction of the search region 322 is set to match with the trajectory of the lanes 210l, 210r. In this case, the length in the widthwise direction of the search region 322 becomes shorter than the initial settings. Accordingly, the range over which the search window 320 is made to move (or scan) within the search region 322 becomes narrower.

### (A2-2-3-2. Vehicle Velocity V)

If the vehicle velocity V is high, there is a greater necessity to notify the driver concerning the illuminated state of a traffic signal 300 that is comparatively far away, whereas if the vehicle velocity V is low, there is less of a need to notify the driver concerning the illuminated state of a traffic signal 300 that is comparatively far away. Thus, according to the present embodiment, the position and size of the search region 322 is changed depending on the vehicle velocity V. More specifically, if the vehicle velocity V is high, the search region 322 is widened to cover a region at which the distance L from the camera 20 is relatively long. On the other hand, if the vehicle velocity V is low, the search region 322 is narrowed to cover a region at which the distance L from the camera 20 is relatively short. Owing to this feature, the traffic signal 300 can be detected using a search region 322 that corresponds to the vehicle velocity V.

### (A2-2-3-3. Yaw Rate Yr)

The trajectory of the lanes 210l, 210r is calculated based on the current peripheral image 100. For example, if the absolute value of a left-leaning yaw rate Yr is relatively large, it can be said that there is a high necessity to know the illuminated state of a traffic signal 300 that is located on the left side of the trajectory of the lanes 210l, 210r. Similarly, if the absolute value of a right-leaning yaw rate Yr is relatively large, it can be said that there is a high necessity to know the illuminated state of a traffic signal 300 that is located on the right side of the trajectory of the lanes 210l, 210r. Thus, according to the present embodiment, the position in the widthwise direction of the search region 322 is modified depending on the yaw rate Yr. For example, the left side of the search region 322 is shifted responsive to an increase in the absolute value of the left-leaning yaw rate Yr.

### (A2-2-3-4. Map Information Im)

Within the map information Im, the distance information Ilmap representing distance to the traffic signal 300 is utilized to determine which one of the search window 320 and the search region 322 should be used. For example, if the next traffic signal 300 is located at a relatively far position from the vehicle 10, the computation unit 52 does not set the search region 322 on the upper side of the image 100. Conversely, if the next traffic signal 300 is located at a relatively near position from the vehicle 10, the computation unit 52 does not set the search region 322 on the lower side of the image 100.

Information of the height H (height information Ihmap) of the traffic signal 300 within the map information Im is combined with the lane information Il or the distance information Ilmap, whereby the range of the search region 322 in the Y-axis direction (height direction) is limited.

If information of the shape (shape information) of the traffic signal 300 is included in the map information Im, by combining the shape information with the lane information Il or the distance information Ilmap, the range of the search region 322 is changed in the x-axis direction (horizontal direction) and the y-axis direction (vertical direction). For example, compared to a case in which the shape of the light emitting section 304 is horizontally elongate, in the case in which the shape of the light emitting section 304 is vertically elongate, the x-axis direction of the search region 322 is made short, and the y-axis direction is made long. By this feature, the scope (and the position) of the search region 322 can be set corresponding to the shape of the light emitting section 304.

### (A2-3. Driving Assistance Control Process)

The driving assistance unit 16 performs driving assistance for the vehicle 10 based on the recognition result of the recognition device 14 (i.e., the presence or absence of the traffic signal 300 and the light emitting state of the light emitting section 304), the sensor information Is, etc. More specifically, the brake ECU 82 specifies the illuminated state of the traffic signal 300 and the distance to the traffic signal 300 based on the traffic signal information Isig from the recognition device 14, etc. For example, in the case that the vehicle 10 is not decelerated in front of the traffic signal 300 despite the fact that the traffic signal 300 is a red-light signal, the brake ECU 82 actuates an automatic braking action by the hydraulic mechanism 80.

Further, the warning ECU 92 specifies the illuminated state of the traffic signal 300 and the distance to the traffic signal 300 based on the traffic signal information Isig from the recognition device 14, etc. For example, in the case that the vehicle 10 is not decelerated in front of the traffic signal 300 despite the fact that the traffic signal 300 is a red-light signal, the warning ECU 92 displays a warning message on the display device 90.

### A3. Advantages of the Present Embodiment

As has been described above, according to the present embodiment, the traffic signal 300 is recognized by a combination of the plurality of the images 100 of frames F (see FIGS. 3 to 5). Therefore, for example, even in the event that the traffic signal 300 is difficult to recognize with a single frame F, as in the case of an LED traffic signal, the traffic signal 300 can still be recognized accurately.

In the present embodiment, the recognition device 14 includes the storage unit 54 in which the light emitting patterns Pl of a plurality of frames F are stored as teacher data (see, FIGS. 1 and 5). The traffic signal detecting unit 62 (traffic signal recognizing unit) recognizes the traffic signal 300 by comparing the light emitting patterns Pl of a plurality of frames F, which are captured by the camera 20 (image capturing unit), and the teacher data (step S10 of FIG. 4). By this feature, since the transitions of the light emitting state of an LED traffic signal, etc., are stored as light emitting patterns Pl and are compared with the teacher data, the LED traffic signal, etc., can be recognized accurately.

According to the present embodiment, if one of a red-light signal or an arrow signal is recognized in a certain frame F, the traffic signal detecting unit 62 (traffic signal recognizing unit) makes it easier for the other of the red-light signal or the arrow signal to be recognized in a next frame F thereafter (steps S5 to S8 of FIG. 4). Accordingly, it becomes easier for a plurality of light emitting lamps Ll, which are recognized as being illuminated simultaneously by the naked eye, to be recognized accurately.

### B. Modifications

The present invention is not limited to the above embodiment, but various alternative or additional arrangements may be adopted therein based on the disclosed content of the present specification. For example, the following arrangements may be adopted.

### B1. Objects in which Recognition Device 14 can be Incorporated

In the above embodiments, the recognition device 14 is incorporated in a vehicle 10. However, the invention is not limited to this feature, and the recognition device 14 may be incorporated in other types of objects. For example, the recognition device 14 may be used in mobile objects such as ships or aircraft, etc. Further, such objects are not limited to mobile objects, and insofar as an apparatus or system is provided that detects the presence of traffic signals 300, the recognition device 14 may be incorporated in such other apparatus or systems.

### B2. Sensor Unit 12

The sensor unit 12 of the above embodiment includes the camera 20, the vehicle velocity sensor 22, the yaw rate sensor 24, and the map information supplying device 26 (see, FIG. 1). However, for example, from the standpoint of recognizing traffic signals 300 (or from the standpoint of identifying the light emitting lamps Ll thereof) using a combination of images 100 of a plurality of frames F, the invention is not limited in this manner. For example, one or more of the vehicle velocity sensor 22, the yaw rate sensor 24, and the map information supplying device 26 may be omitted.

Alternatively, other sensors can be used in addition to or in place of one or more of the vehicle velocity sensor 22, the yaw rate sensor 24, and the map information supplying device 26. As examples of such sensors, there can be used an inclination sensor for detecting an inclination A [deg] of the vehicle 10 (vehicle body). Further, the computation unit 52 can correct the position in the Y direction (vertical direction) of the search window 320 and the search region 322 corresponding to the inclination A.

In the above embodiment, the camera 20 is assumed to be fixedly attached to the vehicle 10. However, for example, from the standpoint of acquiring a peripheral image 100 in the direction of travel of the vehicle 10 (or mobile object), the invention is not necessarily limited to this feature. For example, the camera 20 may be incorporated in a mobile information terminal possessed by a pedestrian who is passing outside of the vehicle 10.

The camera 20 of the above embodiment is premised on being attached to the vehicle 10, and having fixed specifications including magnification, angle of view, etc. However, for example, from the standpoint of acquiring a peripheral image 100 in the direction of travel of the vehicle 10 (or mobile object), the invention is not limited to this feature. For example, the camera 20 may have variable specifications.

The camera 20 of the above embodiment is premised on being a single camera (monocular camera). However, for example, from the standpoint of acquiring a peripheral image 100 in the direction of travel of the vehicle 10 (or mobile object), a stereo camera can also be used.

In the above embodiment, the map DB 32 of the map information supplying device 26 is arranged inside the vehicle 10 (see, FIG. 1). However, from the standpoint of acquiring map information Im, for example, the computation unit 52 may acquire the map information Im from a non-illustrated external server (external apparatus) or a roadside beacon.

### B3. Surrounding Environment Recognition Device 14

According to the above embodiment, the computation unit 52 includes the lane detecting unit 60 and the traffic signal detecting unit 62 (see, FIG. 1). However, for example, insofar as attention remains focused on detecting traffic signals 300, the lane detecting unit 60 can be omitted.

### B4. Driving Assistance Unit 16

The driving assistance Unit 16 of the above embodiment includes the brake device 70 and the warning device 72 (see, FIG. 1). However, for example, from the standpoint of recognizing traffic signals 300 (or from the standpoint of identifying the light emitting lamps Ll thereof) using a combination of images 100 of a plurality of frames F, the present invention is not limited to this feature. For example, one or both of the brake device 70 and the warning device 72 can be omitted.

Alternatively, other driving assistance devices can be provided in addition to or in place of the brake device 70 and/or the warning device 72. As examples of such other types of driving assistance devices, there can be included a device (high efficiency driving support device) that carries out notifications with the aim of improving energy efficiency (fuel consumption, etc.) The high efficiency driving support device can assist in high efficiency driving by prompting the driver to control the vehicle velocity V so as not to have to stop the vehicle 10 at traffic signals 300.

The warning device 72 of the above embodiment serves to provide notification of the existence of the traffic signal 300 by means of a display on the display device 90 (see FIG. 1). However, for example, from the standpoint of providing notification of the existence of a traffic signal 300, the invention is not limited to this feature. For example, in place of or in addition to a display, a notification of the existence of a traffic signal 300 can be provided by a voice output through a speaker.

### B5. Traffic Signal 300

In the above embodiment, the traffic signal 300 has been described by way of example as having the green-light lamp 310, the yellow-light lamp 312, the red-light lamp 314, the left turn permission lamp 316a, the straight forward permission lamp 316b, and the right turn permission lamp 316c (see, FIG. 2, etc.). However, traffic signals 300 to which the traffic signal detection control process of the present invention can be applied are not limited to such features. For example, the traffic signal 300 may not necessarily include the arrow lamps 316a to 316c, or may include only one or two of the arrow lamps 316a to 316c.

### B6. Traffic Signal Detection Control Process

### (B6-1. Use of Sensor Information Is)

According to the above embodiment, the search region of the search window 320 is set using the image information Ii, the vehicle velocity V, the yaw rate Yr, and the map information Im (step S2 of FIG. 4). However, for example, from the standpoint of using the search window 320, the invention is not limited to this feature. For example, it is possible for one or more of the vehicle velocity V, the yaw rate Yr, and the map information Im not to be used.

### (B6-2. Search Window 320)

According to the above embodiment, the region occupied by the search window 320 was assumed to include a plurality of pixels. However, for example, from the standpoint of detecting any of the light emitting lamps Ll, the invention is not limited to this feature. For example, the region of the search window 320 may be one pixel, and an emitted color may be detected by one pixel each. In addition, if the computation unit 52 detects an emission color corresponding to a light emitting lamp Ll, the presence of any of the light emitting lamps Ll can be identified by pattern matching around the periphery of the detected emission color.

### (B6-3. Brightness Threshold THb)

According to the above embodiment, in one frame image 100, if one of the red-light lamp 314 or the arrow lamps 316a to 316c is detected, for the following three frames F thereafter, the brightness threshold THb for the arrow lamps 316a to 316c or the red-light lamp 314 is lowered (steps S5 to S8 of FIG. 4). However, for example, from the standpoint of recognizing traffic signals 300 (or from the standpoint of identifying the light emitting lamps Ll thereof) using a combination of images 100 of a plurality of frames F, the brightness threshold THb is not limited to being used in this way. For example, in relation to the traffic signal 300 that is an object to be detected, the brightness threshold THb may be lowered for all of the subsequent frames F thereafter, or the brightness threshold THb may be lowered for a specified number of frames F. For example, if the predetermined number of frames Nf is ten, then the number of frames F for which the brightness threshold THb is lowered may be any number from one to nine, for example.

Further, according to the above embodiment, in the frame image 100 that is the current object of calculation, if one of the red-light lamp 314 and the arrow lamps 316a to 316c is detected, for the subsequent frames F, the brightness threshold THb for the arrow lamps 316a to 316c or the red-light lamp 314 is lowered (steps S5 to S8 of FIG. 4). However, for example, if one of a red-light signal and an arrow signal is recognized in a certain frame, from the standpoint of making it easier for the other one of the red-light signal and the arrow signal to be recognized in a next frame thereafter or in a previous frame therebefore, the invention is not limited to this feature.

For example, concerning a frame image 100 that is the current calculation target, in a case where a pixel or a pixel group whose brightness is slightly less than the brightness threshold THb for determining the red-light lamp 314 or the arrow lamps 316a to 316c, is detected, if the arrow lamps 316a to 316c or the red-light lamp 314 was already detected in a frame image 100 that was the previous calculation target, then the red-light lamp 314 or the arrow lamps 316a to 316c can be determined. Alternatively, concerning a frame image 100 that is the current calculation target, in a case where a pixel or a pixel group whose brightness is slightly less than the brightness threshold THb for determining the red-light lamp 314 or the arrow lamps 316a to 316c, is detected, if the arrow lamps 316a to 316c or the red-light lamp 314 is detected in a frame image 100 that is the next calculation target, then the red-light lamp 314 or the arrow lamps 316a to 316c may be determined in the frame image 100 that is the current calculation target (but has already become the previous calculation target at the time of this determination).

According to the above embodiment, in one frame image 100, if one of the red-light lamp 314 and the arrow lamps 316a to 316c is detected, the brightness threshold THb for the arrow lamps 316a to 316c or the red-light lamp 314 is lowered (steps S5 to S8 of FIG. 4). However, for example, from the standpoint of recognizing traffic signals 300 (or from the standpoint of identifying the light emitting lamps Ll thereof) using a combination of images 100 of a plurality of frames F, the brightness threshold THb is not limited to being used in this way. For example, steps S5, S6 and/or steps S7, S8 can be omitted. Alternatively, in a case where a lamp was detected in a certain frame F, the brightness threshold THb for the lamp itself can be lowered in the subsequent frames F. For example, if the red-light lamp 314 is detected in a certain frame F, in the following frames F thereafter, the threshold value THb for the red-light lamp 314 itself may be lowered.

In the above embodiment, determination of the arrow lamps 316a to 316c or the red-light lamp 314 using the brightness threshold THb has mainly been described (steps S3, S5 to S8 of FIG. 4, etc.). However, for example, from the standpoint of recognizing traffic signals 300 (or from the standpoint of identifying the light emitting lamps Ll thereof) using a combination of images 100 of a plurality of frames F, the invention is not limited to this way. For example, the arrow lamps 316a to 316c or the red-light lamp 314 can also be determined by setting a threshold on a vector space in which shapes and colors, etc., for each of the lamps are included. By doing so, traffic signals 300 can be recognized with even better accuracy.

### B6-4. Use of Acquired Data

According to the above embodiment, the light emitting lamps Ll are identified by comparing the acquired data with teacher data (step S10 of FIG. 4). However, for example, from the standpoint of recognizing traffic signals 300 (or from the standpoint of identifying the light emitting lamps Ll thereof) using a combination of images 100 of a plurality of frames F, the present invention is not limited to the above.

### (B6-4-1. First Modification)

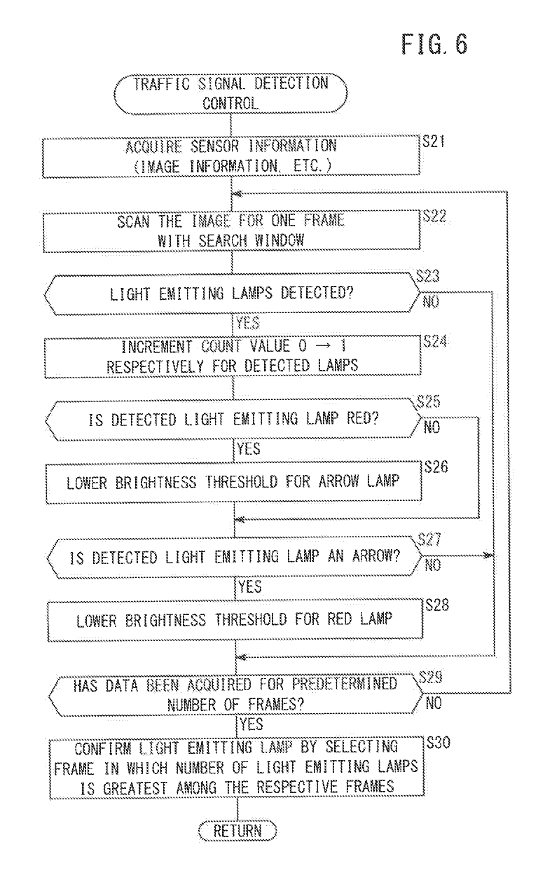

FIG. 6 is a flowchart of a traffic signal detection control process according to a first modification. In the example of FIG. 6, among the respective frames F, a frame having a greatest number Nll of light emitting lamps Ll therein is selected to specify the light emitting lamps Ll.

Steps S21 to S29 of FIG. 6 are the same as steps S1 to S9 of FIG. 4. In step S29, if data of a predetermined number of frames Nf have been acquired (step S29: YES), then in step S30, the computation unit 52 determines the light emitting lamps Ll by selecting a frame in which the number Nll of the light emitting lamps Ll is the greatest, from among the frames F. For example, in the example shown in FIG. 3, the numbers Nll of light emitting lamps Ll in the frames F1 to F4 are 3, 1, 0, and 2, respectively. Therefore, if the frames F1 to F4 are compared in FIG. 3, the frame in which the number Nll of light emitting lamps Ll is the greatest is frame F1 (Nll=3). Consequently, the computation unit 52 selects the frame F1, and determines that the red-light lamp 314 and the arrow lamps 316a to 316b are the light emitting lamps Ll.

According to the first modification, the traffic signal detecting unit 62 (traffic signal recognizing unit) confirms the light emitting lamps Ll that are included in the one of the frames F that has the greatest number Nll of light emitting lamps Ll, as being the light emitting lamps Ll (step S30 of FIG. 6). In accordance with this feature, a plurality of signal lamps (for example, any of the red-light lamp 314 and the arrow lamps 316a to 316c), which are illuminated simultaneously, can be recognized more accurately.

### (B6-4-2. Second Modification)

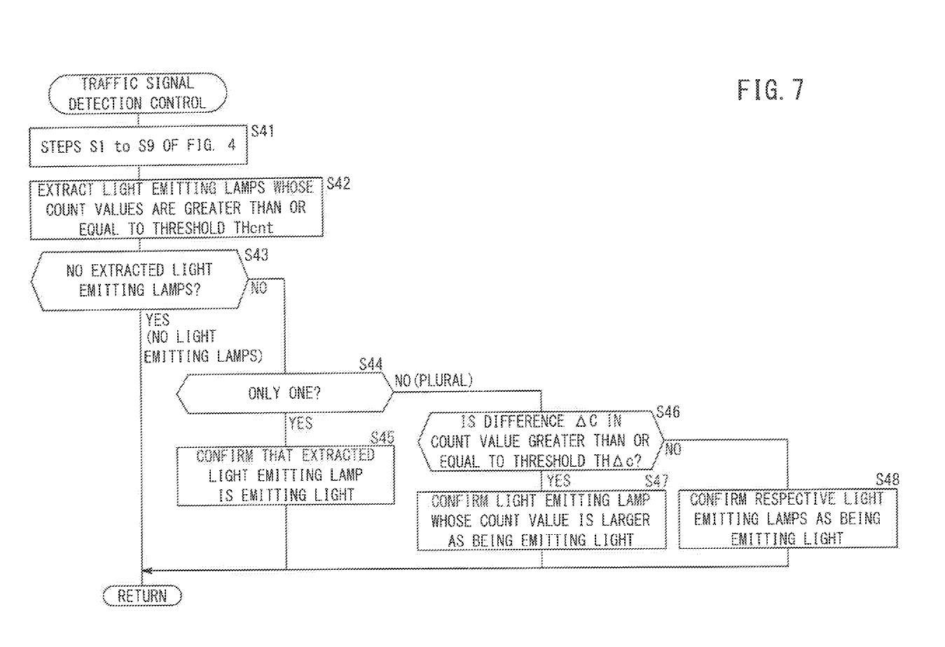

FIG. 7 is a flowchart of a traffic signal detection control process according to a second modification. In the example of FIG. 7, the light emitting lamps Ll are specified using a count value CNT (total value) of each of the light emitting lamps Ll that are detected in the respective frames F.

Step S41 of FIG. 7 is the same as steps S1 to S9 of FIG. 4. However, in the step that corresponds to step S4 of FIG. 4, a count value CNT (total value) of each of the light emitting lamps Ll, which are detected in the respective frames F, is calculated.

For example, among the frames F1 to F4 shown in FIG. 3, the red-light lamp 314 is emitting light in frames F1 and F2. Therefore, if the combination of frames F1 to F4 of FIG. 3 is used, the count value CNT for the red-light lamp 314 is 2. Similarly, among the frames F1 to F4 shown in FIG. 3, the left turn permission lamp 316a is emitting light in frames F1 and F4. Therefore, if the combination of frames F1 to F4 of FIG. 3 is used, the count value CNT for the left turn permission lamp 316a is 2.

In step S42, the computation unit 52 extracts light emitting lamps Ll the respective count values CNT of which are greater or equal to a count threshold THcnt. The count threshold THcnt is a threshold value for specifying the light emitting lamps Ll, and in the example of FIG. 7, is 2. The count threshold THcnt can be set corresponding to the predetermined number of frames Nf (step S41 of FIG. 7, step S9 of FIG. 4), and for example, may be any value from 2 to 5.

In step S43, the computation unit 52 determines whether or not there are light emitting lamps Ll that were extracted in step S42. If there are no extracted light emitting lamps Ll (step S43: YES), then it is determined that there are no light emitting lamps Ll in the current calculation cycle. Therefore, the current process is terminated, and after elapse of a predetermined time period, the process is repeated from step S41.

If there are extracted light emitting lamps Ll (step S43: NO), then in step S44, the computation unit 52 makes a judgment as to whether or not there is only one extracted light emitting lamp Ll. If only one light emitting lamp Ll is extracted (step S44: YES), then in step S45, the computation unit 52 confirms that the extracted light emitting lamp Ll is emitting light.

If more than one light emitting lamp Ll are extracted (step S44: NO), then it is determined that plural light emitting lamps Ll are extracted. In this case, in step S46, the computation unit 52 determines whether or not each of mutual differences ΔC in the count values CNT of the plurality of extracted light emitting lamps Ll,

respectively, is greater than or equal to a predetermined threshold value THΔc. Although the threshold value THΔc in the example of FIG. 7 is two, for example, the threshold value can be set corresponding to the predetermined number of frames Nf (step S41 of FIG. 7, step S9 of FIG. 4).

If the difference ΔC is greater than or equal to the threshold value THΔc (step S46: YES), one light emitting lamp Ll whose count value CNT is smaller can be presumed to be of low reliability. Thus, in step S47, the computation unit 52 confirms only the other light emitting lamp Ll whose count value CNT is larger, as being the light emitting lamp Ll.

If the difference ΔC is not greater than or equal to the threshold value THΔc (step S46: NO), then any of the light emitting lamps Ll can be presumed to be of high reliability. Thus, in step S48, the computation unit 52 confirms that the respective light emitting lamps Ll are emitting light.

According to the second modification, the traffic signal detecting unit 62 (traffic signal recognizing unit) confirms a light emitting lamp Ll whose count value CNT (recognition count) in a plurality of frames F has exceeded the count threshold THcnt (recognition count threshold), as being the light emitting lamp Ll (steps S45, S47 and S48 of FIG. 7). By this feature, the illuminated state of a traffic signal 300 can be judged more accurately because a light emitting lamp Ll, which otherwise would be mistakenly detected in a signal frame F, is not confirmed as being a light emitting lamp Ll.

Further, according to the second modification, if there are plural light emitting lamps Ll whose respective count values CNT (recognition count) have exceeded the count threshold THcnt (step S44 of FIG. 7: NO), and a difference ΔC in the count value CNT therebetween is greater than or equal to a threshold THΔc (difference threshold) (step S46: YES), then the traffic signal detecting unit 62 (traffic signal recognizing unit) confirms that only the light emitting lamp Ll having a larger count value CNT is a light emitting lamp Ll (step S47). In accordance with this feature, it is possible to improve the accuracy (detection accuracy) with which light emitting lamps Ll are recognized by a relationship between the light emitting lamps Ll themselves.

What is claimed is:

1. A surrounding environment recognition device, comprising:
an image capturing unit that captures a peripheral image; and
a traffic signal recognizing unit that recognizes a traffic signal from within the peripheral image, wherein:
the image capturing unit captures a plurality of images of frames; and
the traffic signal recognizing unit recognizes the traffic signal based on a combination of the plurality of images of frames.

2. The surrounding environment recognition device according to claim 1, wherein:
the surrounding environment recognition device includes a storage unit in which a light emitting pattern of a plurality of frames is stored as teacher data; and
the traffic signal recognizing unit recognizes the traffic signal by comparing a light emitting pattern of the plurality of frames captured by the image capturing unit and the teacher data.

3. The surrounding environment recognition device according to claim 1, wherein the traffic signal recognizing unit confirms light emitting lamps that are included in one of the plurality of frames that has a greatest number of light emitting lamps therein, as being the light emitting lamps.

4. The surrounding environment recognition device according to claim 1, wherein if one of a red-light signal and an arrow signal is recognized in a certain frame, the traffic signal recognizing unit makes it easier for another of the red-light signal and the arrow signal to be recognized in a next frame thereafter or in a previous frame therebefore.

5. The surrounding environment recognition device according to claim 1, wherein if one of a red-light signal and an arrow signal is recognized in a certain frame, the traffic signal recognizing unit makes it easier for the one of the red-light signal and the arrow signal to be recognized in a next frame thereafter or in a previous frame therebefore.

6. The surrounding environment recognition device according to claim 1, wherein the traffic signal recognizing unit confirms a light emitting lamp whose recognition count in the plurality of frames has exceeded a recognition count threshold, as being the light emitting lamp.

7. The surrounding environment recognition device according to claim 6, wherein, if there are plural light emitting lamps whose respective recognition counts have exceeded the recognition count threshold, and a mutual difference in the recognition count between the light emitting lamps is greater than or equal to a difference threshold, then the traffic signal recognizing unit confirms only the light emitting lamp having a larger recognition count, as being the light emitting lamp.
